(19) United States
(12) Patent Application Publication
(10) Pub. No.: US 2019/0004389 A1
(43) Pub. Date: Jan. 3, 2019

(54) LIGHT REFLECTIVE MATERIAL AND LIGHT CONTROL DEVICE

(71) Applicant: SHARP KABUSHIKI KAISHA, Sakai City, Osaka (JP)

(72) Inventors: NOBUYUKI ITO, Sakai City (JP); EIJI SATOH, Sakai City (JP); YUFENG WENG, Sakai City (JP)

(73) Assignee: SHARP KABUSHIKI KAISHA, Sakai City ,Osaka (JP)

(21) Appl. No.: 16/065,046

(22) PCT Filed: Aug. 24, 2016
(86) PCT No.: PCT/JP2016/074584

§ 371 Date: Jun. 21, 2018

(30) Foreign Application Priority Data
Dec. 22, 2015 (JP) 2015-250545

(51) Int. Cl. G02F 1/167; E06B 9/24; E06B 3/67; C03C 17/34

(52) U.S. Cl. CPC G02F 1/167; E06B 9/24; E06B 3/6722; G02F 1/133345; G02F 2001/1678; G02F 2202/16; C03C 17/3417

(57) ABSTRACT

Provided is a light reflective material that enables stable switching between light transmission and light reflection when used in a light control device. A light reflective material includes a base, a conducting film that is stacked on the surface of the base, and an insulating film that is stacked on the surface of the conducting film. A first region where the conducting film is not formed is present in a layer where the conducting film lies. A second region where the insulating film is not formed is present in a layer where the insulating film lies. The first region and the second region at least partially overlap each other.

### TECHNICAL FIELD

The discloser relates to a light reflective material that reflects light with a particular wavelength, and a light control device including the light reflective material.

### BACKGROUND ART

In recent years, electrochromic windows having a light control function, called smart windows, have been put in practical use. Electrochromic windows can control light transmittance in response to voltage application.

As an example of electrochromic windows, PTL 1 discloses an infrared light control device that can switch between the transmission and reflection of infrared light by voltage application to shape anisotropic components (light reflective materials). PTL 2 discloses an electrochromic method associated with light modulation through reflection or transmission.

### CITATION LIST

### Patent Literature

PTL 1: International Publication No. WO 2015/40975 (published Mar. 26, 2015)

PTL 2: Japanese Unexamined Patent Application Publication No. 1-48044 (published Feb. 22, 1989)

### SUMMARY OF INVENTION

### Technical Problem

In the light control device including shape anisotropic components as described in PTL 1, the shape anisotropic components may move and aggregate in response to voltage application. The repeated voltage application generates regions rich in shape anisotropic component and regions poor in shape anisotropic component. As a result, stable switching between light transmission and light reflection may be unsuccessful.

In light of the foregoing issue, the discloser is directed to a light reflective material that, when used in a light control device, enables stable switching between light transmission and light reflection.

### Solution to Problem

To solve the foregoing issue, a light reflective material according to an aspect of the discloser is a light reflective material that reflects light with a particular wavelength. The light reflective material comprising a light-transmissive base, a conducting film that is stacked on the surface of the base and reflects the light with a particular wavelength, and an insulating film that is stacked on the surface of the conducting film. A first region where the conducting film is not formed is present in a layer where the conducting film lies. A second region where the insulating film is not formed is present in a layer where the insulating film lies. The first region and the second region at least partially overlap each other.

A light reflective material according to an aspect of the discloser is a light reflective material that reflects light with a particular wavelength. The light reflective material includes a base that reflects the light with a particular wavelength, a conducting film that is stacked on the surface of the base, and an insulating film that is stacked on the surface of the conducting film. A first region where the conducting film is not formed is present in a layer where the conducting film lies. A second region where the insulating film is not formed is present in a layer where the insulating film lies. The first region and the second region at least partially overlap each other.

### Advantageous Effects of Invention

A light reflective material according to an aspect of the discloser enables stable switching between light transmission and light reflection when used in a light control device.

### BRIEF DESCRIPTION OF DRAWINGS

FIG. 1(a) is a perspective view of a light reflective material according to a first embodiment of the discloser; FIG. 1(b) is a cross-sectional view taken along line A-A in the perspective view (a) of the light reflective material according to the first embodiment of the discloser; and FIG. 1(c) is a cross-sectional view of another light reflective material according to the first embodiment of the discloser.

FIG. 2 is a cross-sectional view showing the structure of a light control device including the light reflective material according to the first embodiment of the discloser.

FIG. 3(a) is a view of the light control device in FIG. 2 in a near-infrared light reflection state; and FIG. 3(b) is a view of the light control device in FIG. 2 in a near-infrared light transmission state.

FIG. 4 illustrates plan-view micrographs showing the orientation state of the light reflective materials when a voltage is applied between opposed electrodes in an actually produced light control device, where FIG. 4(a) is a micrograph when a direct current voltage of 2 V is applied between the electrodes and FIG. 4(b) is a micrograph when an alternating voltage of 5 V at 60 Hz is applied between the electrodes.

FIG. 5 is a view of an example method for producing the light reflective material illustrated in FIG. 1(c).

FIG. 6(a) is a cross-sectional view showing the structure of a light reflective material of Comparative Example; and FIG. 6(b) is a cross-sectional view showing the structure of a light reflective material according to another Comparative Example.

FIG. 7(a) is a micrograph when a light control device of Comparative Example in a near-infrared light reflection state is observed from a light-receiving side; FIG. 7(b) is a micrograph when the light control device of Comparative Example is switched to a near-infrared light transmission state; FIG. 7(c) is a micrograph when a light control device according to this embodiment in a near-infrared light reflection state is observed from a light-receiving side; and FIG. 7(d) is a micrograph when the light control device according to this embodiment is switched to a near-infrared light transmission state.

FIG. 8 is a view showing a method for producing the light reflective material according to a second embodiment of the discloser.

FIG. 9(a) is a view showing the structure of a light reflective material wafer according to a third embodiment of the discloser; and FIG. 9(b) is a view showing the light reflective material wafer when it has been ground into small pieces.

FIG. 10(a) is a view showing the structure of a light reflective film according to a fourth embodiment of the discloser; and FIG. 10(b) is a view showing the light reflective film when it has been divided into small pieces.

### DESCRIPTION OF EMBODIMENTS

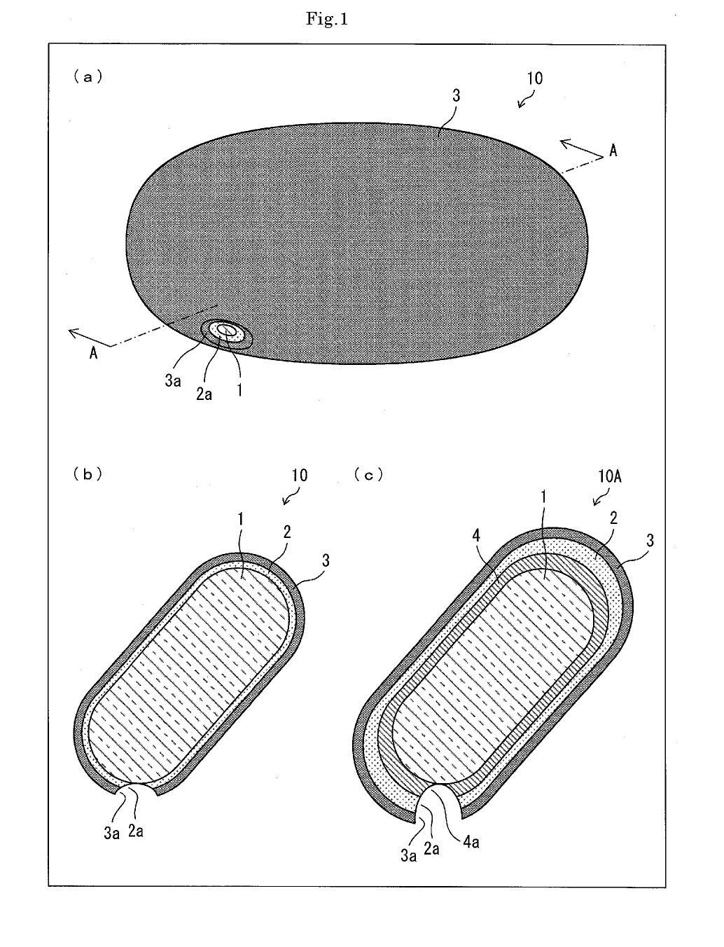

Embodiments of the discloser will be described below with reference to FIG. 1 to FIG. 7. In the embodiments, a light reflective material 10 that reflects near-infrared light, and a light control device 100 including the light reflective material 10 will be described.

### (Light Control Device 100)

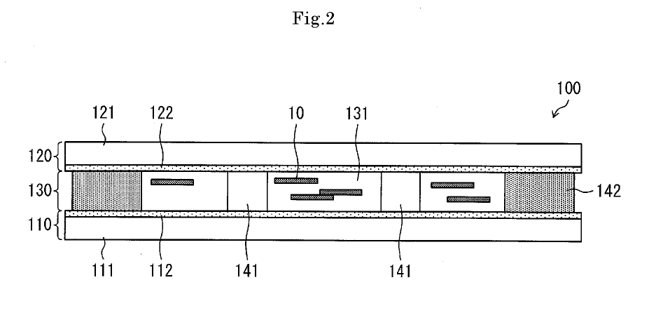

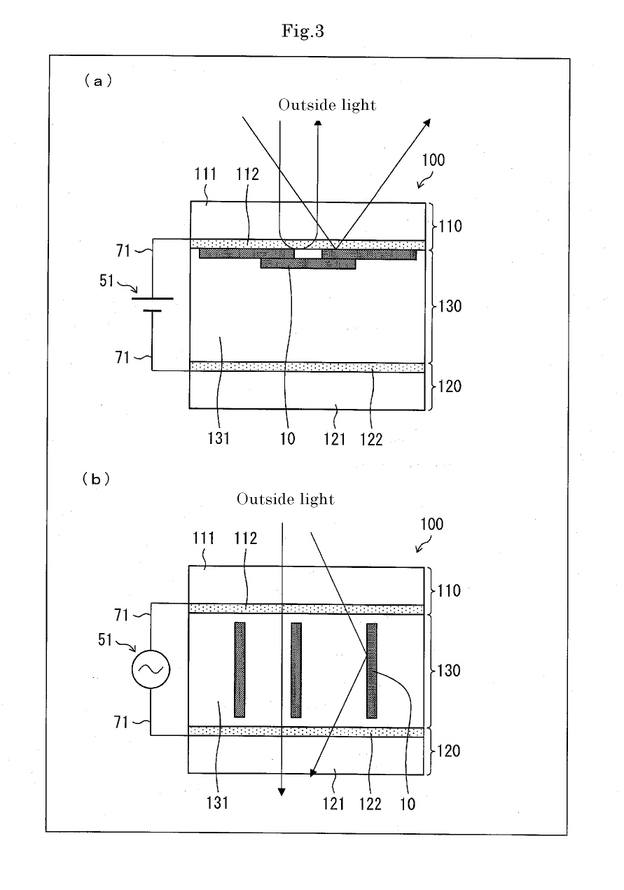

FIG. 2 is a cross-sectional view showing the structure of the light control device 100 including the light reflective material 10 according to this embodiment. The light control device 100 is a near-infrared light control device using a light control method in which light is controlled by rotation of the light reflective material 10. As illustrated in FIG. 2, the light control device 100 is a light control cell including a pair of substrates 110 and 120 disposed opposite to each other and a light modulation layer 130 disposed between the pair of substrates 110 and 120. As illustrated in FIG. 3(a) and FIG. 3(b) described below, the light control device 100 further includes a power source 51.

The light reflective material 10 has a function of reflecting near-infrared light. The use of the light reflective material 10 in the light control device 100 installed in a window enables control of near-infrared light entering the room and can make an indoor environment comfortable. The light reflective material 10 will be described below.

### (Substrates 110 and 120)

The substrate 110 includes an insulating substrate 111 and an electrode 112. Similarly, the substrate 120 includes an insulating substrate 121 and an electrode 122.

The insulating substrates 111 and 121 are formed of, for example, a transparent glass substrate or a plastic substrate. In the case of using a glass substrate as the insulating substrates 111 and 121, the edge of the glass is clean-cut and may be chamfered by, for example, polishing in order to prevent thermal cracking.

The electrodes 112 and 122 are transparent electrodes and formed of, for example, a transparent conducting film that has a low carrier content and transmits near-infrared light to some extent. The electrodes 112 and 122 are formed of, for example, a material that has a transmittance of 50% for near-infrared light with a wavelength of 1000 nm and a transmittance of 50% or higher for near-infrared light with a wavelength of 1500 nm. Specific examples of the material of the electrodes 112 and 122 include titanium-doped indium oxide (InTiO), tantalum substituted tin oxide containing anatase type titanium dioxide as a seed layer, indium tin oxide (ITO), indium zinc oxide (IZO), zinc oxide, and tin oxide. The electrodes 112 and 122 are connected to the power source 51 through wiring lines 71 (see FIG. 3). The power source 51 is a power source that can apply a direct current voltage or an alternating voltage between the electrodes 112 and 122.

The substrate 110 and the substrate 120 are bonded to each other through a sealing material 142 disposed in the edges of the substrates 110 and 120. The sealing material 142 is preferably, for example, an UV (ultraviolet) curable resin. Preferably, the sealing material 142 includes a sealing material with solvent resistance on the inner side in contact with a medium 131 described below and a sealing material with high adhesive power on the outer side.

Spacers 141 are provided on the surface of one of the substrates 110 and 120, the surface being a surface that opposes the other substrate. In this embodiment, for example, the spacers 141 with a width of 200 μm and a height of 200 μm were formed by photolithography. The spacers 141 provided between the substrates 110 and 120 can maintain the substrates 110 and 120 at a constant distance from each other.

### (Light Modulation Layer 130)

A light modulation layer 130 is provided between the electrodes 112 and 122. The light modulation layer 130 includes a medium 131 and plural light reflective materials 10 held by the medium 131.

The medium 131 is a substance that has fluidity and holds the light reflective material 10. In order for the medium 131 to function as a window, for example, a liquid that does not absorb light in the visible range or such a liquid colored with a dye is used as the medium 131. The medium 131 has a higher dielectric constant than glass and preferably has a higher dielectric constant of 20 or higher.

The medium 131 may be formed of a single substance or may be formed of a mixture of plural substances. Examples of the material of the medium 131 include propylene carbonate, N-methyl-2-pyrrolidone (NMP), fluorocarbon, and silicone oil.

In the production of the light control device 100, a dispersion (light reflective material mixture) prepared by using, for example, propylene carbonate as the medium 131 and dispersing the light reflective materials 10 in the medium 131 at a proportion of, for example, 20 wt % is dropped on one of the substrates 110 and 120 on which the sealing material 142 has been formed.

The substrate on which the dispersion is dropped preferably has, for example, an UV curable resin as the sealing material 142 and more preferably has a sealing material with solvent resistance on the inner side in contact with the medium 131 and a sealing material with high adhesive power on the outer side.

The substrates 110 and 120 are bonded to each other while the dispersion is dropped on the substrate. The sealing material 142 is then cured to produce the light control device 100 according to this embodiment.

The light control device 100 is a light control device that controls near-infrared light. The substrates 110 and 120 and the medium 131 are preferably made of a substance with low near-infrared absorptivity. If the substrates 110 and 120 and the medium 131 are made of a substance with high near-infrared absorptivity, and the light control device 100 is in the near-infrared light transmission state, the substrates 110 and 120 or the medium 131 absorbs near-infrared light. As a result, the intensity of near-infrared light passing through the light control device 100 decreases.

If the medium 131 has high viscosity, the orientation state of the light reflective material 10 can be maintained, but the drive voltage may be high. In the case where the transmission of near-infrared light through a window into the room is controlled by providing the light control device 100 in the window, the control operation is carried out about several times a day. In the case where maintaining the state of the light reflective material 10 although the drive voltage is high is advantageous in low power consumption of the light control device 100, a medium with viscosity high enough to maintain the state of the light reflective material 10 can be used as the medium 131.

To increase the viscosity of the medium 131, a medium having high viscosity as it is, such as silicone oil or polyethylene glycol, may be used as the medium 131; poly(methyl methacrylate) (PMMA) or the like may be added to the medium 131; or a thixotropic material, such as silica fine particles, may be added to the medium 131.

In particular, when thixotropy is imparted to the medium 131 by addition of a thixotropic material to the medium 131, the thixotropic material can prevent or reduce settling of the light reflective materials 10 and allows the medium 131 to remember the operational state of the light control device 100, reducing voltage application frequency and lowering power consumption.

### (Near-Infrared Light Transmittance Control)

Next, a method for controlling the transmittance of near-infrared light by using the light modulation layer 130 will be specifically described. with reference to FIG. 3(a) and FIG. 3(b). FIG. 3(a) is a view showing a near-infrared light reflection state, and FIG. 3(b) is a view showing a near-infrared light transmission state.

When, for example, a direct current voltage (frequency=0 Hz) of 2 V is applied between the opposed electrodes 112 and 122 from the power source 51, the charged light reflective materials 10 are moved to one electrode by means of electrophoresis. The near-infrared light reflection state illustrated in FIG. 3(a) is obtained accordingly. At this time, an alternating voltage at a frequency as low as 1 Hz or less may be applied between the electrodes 112 and 122 instead of a direct current voltage to prevent what is called burn-in.

FIG. 3(a) illustrates an example in which the light reflective materials 10 are oriented so as to adhere to the electrode 112 in the substrate 110. In FIG. 3(a), the positive terminal of the power source 51 is connected to the electrode 112, and the negative terminal of the power source 51 is connected to the electrode 122. However, the configuration is not limited to this, and the negative terminal of the power source 51 may be connected to the electrode 112, and the positive terminal of the power source 51 may be connected to the electrode 122. When the negative terminal of the power source 51 is connected to the electrode 112 and the positive terminal of the power source 51 is connected to the electrode 122, the light reflective material 10 is oriented so as to adhere to the substrate 120. FIG. 3(a) illustrates the case where the polarity of an electric charge carried by the light reflective materials 10 is negative. The polarity of an electric charge carried by the light reflective materials 10 is not necessarily negative and may be positive. In this case, the light reflective materials 10 adhere to a substrate different from that in the case of FIG. 3(a).

When a direct current voltage at a frequency of 0 Hz or an alternating voltage at a frequency as low as 1 Hz or less is applied to the light modulation layer 130, the charged light reflective materials 10 approach the electrode carrying an electric charge with a polarity opposite to the polarity of an electric charge carried by the light reflective materials 10 due to a force defined as the electrophoretic force or Coulomb force. The light reflective materials 10 then take the most stable orientation and rotate so as to adhere to the substrate 110 or the substrate 120. When the light reflective materials 10 thus orient such that their major axes are parallel to the substrates 110 and 120, light (outside light) incident on the light modulation layer 130 from the substrate 110 side is blocked by the light reflective materials 10 and does not penetrate (pass through) the light modulation layer 130.

When an alternating voltage of 5 V at a frequency higher than that in the case of FIG. 3(a), for example, at a frequency of 60 Hz is applied between the opposed electrodes 112 and 122, the light reflective materials 10 operate in the direction perpendicular to the substrates 110 and 120 as illustrated in FIG. 3(b) due to the dielectrophoresis phenomenon, the Coulomb force, or a force described from an electrical energy viewpoint, thereby providing the near-infrared light transmission state.

In other words, application of an alternating voltage at a frequency of, for example, 60 Hz to the light modulation layer 130 causes the light reflective materials 10 to orient such that their major axes are parallel to the lines of electric force. That is, the light reflective materials 10 orient such that their major axes are parallel to the substrates 110 and 120. For this, light (outside light) incident on the light modulation layer 130 from the substrate 110 side penetrates (passes through) the light modulation layer 130 and exits from the substrate 120 side.

The frequency at which the orientation state of the light reflective materials 10 is switched is set in advance in accordance with, for example, the shape and material of the light reflective material 10 and the thickness (cell thickness) of the light modulation layer 130.

FIGS. 4(a) and 4(b) illustrate plan-view micrographs showing the orientation state of the light reflective materials 10 when a voltage is applied between the opposed electrodes 112 and 122 in the light control device 100 (light control cell) actually produced. FIG. 4(a) is a micrograph when a direct current voltage of 2 V is applied between the electrodes 112 and 122 and FIG. 4(b) is a micrograph when an alternating voltage of 5 V at 60 Hz is applied between the electrodes 112 and 122.

As illustrated in FIG. 4(a), the application of a direct current voltage between the electrodes 112 and 122 causes the light reflective materials 10 to orient in a direction substantially parallel to the substrates 110 and 120. Therefore, the near-infrared light incident on the light control cell is reflected off the light-receiving surface.

As illustrated in FIG. 4(b), the application of an alternating voltage between the electrodes 112 and 122 causes the light reflective materials 10 to orient in a direction perpendicular to the substrates 110 and 120. In FIG. 4(b), the cross section of the light reflective materials 10 is observed in a plan view. The near-infrared light incident on the light control cell travels toward the surface opposite to the light-receiving surface and penetrates the light control cell.

In this embodiment, the substrate 110 of the light control device 100 is disposed on the outdoor side and the substrate 120 is disposed on the indoor side. In the near-infrared light reflection state illustrated in FIG. 3(a) and FIG. 4(a), the near-infrared light incident from the outdoors is regularly reflected off the light reflective material 10 in the light control device 100, that is, effectively reflected off the light-receiving surface.

In the near-infrared light transmission state illustrated in FIG. 3(b) and FIG. 4(b), the near-infrared light incident from the outdoors penetrates the light control device 100 to the indoor side. In the near-infrared light transmission state, the near-infrared light incident from the outdoors onto the substrate surface (light-receiving surface) of the substrate 110 in an oblique direction as illustrated in FIG. 3(b) is reflected off the light reflective material 10. The near-infrared light then strikes the substrate 120 on the indoor side.

### (Light Reflective Material 10)

FIG. 1(a) is a perspective view showing the light reflective material 10 according to this embodiment. FIG. 1(b) is a cross-sectional view taken along line A-A in FIG. 1(a) of the light reflective material 10 according to this embodiment. FIG. 1(c) is a cross-sectional view showing a light reflective material 10A according to this embodiment.

As illustrated in FIG. 1(a) and FIG. 1(b), the light reflective material 10 includes a base 1, a conducting film (near-infrared-light reflective film), and an insulating film 3. Specifically, the conducting film 2 and the insulating film 3 are continuously formed on the base 1. As used herein, the term “continuously formed” means that, after the conducting film 2 is formed, the insulating film 3 is formed without changing a portion of one base 1 contact with another base 1 or a portion of one base 1 in contact with a stage or the like on which the base 1 is placed.

With regard to the size of the light reflective material 10, the light reflective material 10 preferably has a diameter of 50 μm or less and a thickness of 20 μm or less. The diameter here is the diameter of a minimum circle circumscribing the light reflective material 10 in a plan view. When the diameter and thickness of the light reflective material 10 are within the foregoing ranges, the light reflective material has a small mass, which reduces an energy needed to switch between the near-infrared light reflection state and the near-infrared light transmission state. When the thickness of the light reflective material 10 is within the foregoing range, the light reflective material 10 is less likely to orient perpendicularly to the substrate 110 or 120 in the near-infrared light reflection state.

Even if the light reflective material 10 has a diameter of larger than 50 μm, for example, a diameter of 100 μm, it is possible to operate the light reflective material 10 by voltage application. The light reflective material 10, however, is less responsive to voltage application. If the light reflective material 10 has a diameter of, for example, 200 μm, there is a need for a voltage as large as 5 V or higher to operate the light reflective material 10. As the applied voltage increases, the Coulomb force interacting between the light reflective materials 10 increases. As a result, the light reflective materials 10 tend to aggregate.

The base 1 is a light-transmissive base on which the conducting film 2 and the insulating film 3 are to be formed. The base 1 is a flake of a substance serving as a material. The base 1 is made of any material that transmits infrared light, such as glass, a film, or a resin. In particular, when the material of the base 1 is glass or zinc oxide, it is easy to form the base 1 such that the light reflective material 10 has the preferred size described above.

The conducting film 2 is a conducting film that is stacked on the surface of the base 1 and reflects infrared light (light with particular wavelengths). In this embodiment, the material of the conducting film 2 is ITO. The conducting film 2 is made of any material that reflects infrared light. Specific examples of the material of the conducting film 2 include, in addition to ITO described above, transparent conducting films such as those made of zinc oxide, and nanoparticles such as those made of Ag.

In particular, the conducting film 2 is preferably a transparent conducting film formed of a material having a visible light transmittance of 50% or more. When the light control device 100 including the light reflective material 10 is used in a window in this case, 50% or more of visible light penetrates the light control device 10 in either of the near-infrared light transmission state and the near-infrared light reflection state. Examples of such a material include indium tin oxide, gallium-doped zinc oxide, aluminum-doped zinc oxide, InGaZnO oxide semiconductors, and these materials doped with an impurity.

In the formation of the conducting film 2, the base 1 has a portion in contact with another base 1 or a stage on which the base 1 is placed. The conducting film 2 is not formed on the contact portion. A first region 2a where the conducting film 2 is not formed is thus present in a layer where the conducting film 2 lies.

The insulating film 3 is stacked on the surface of the conducting film 2. The insulating film 3 is formed of a material having no conductivity. In this embodiment, the material of the insulating film 3 is SiO₂. The material of the insulating film 3 is not limited to SiO₂ and may be, for example, TiO₂, Al₂O₃, SiN, TiN, or a resin, such as polyimide. The insulating film 3 is made of any material that does not dissolve or swell in the medium 131 included in the light control device 100.

For the same reason that a first region 2a where the conducting film 2 is not formed is present in part of a layer where the conducting film 2 lies, a second region 3a where the insulating film 3 is not formed is present in a layer where the insulating film 3 lies. The insulating film 3 is formed continuously with the conducting film 2. The first region 2a and the second region 3a at least partially overlap each other. As used herein, the term “at least partially overlap each other” means that there is at least one plane where the first region 2a and the second region 3a overlap each other in the cross section of the light reflective material 10 taken along the plane.

The light reflective material according to this embodiment may be the light reflective material 10A illustrated in FIG. 1(c). The light reflective material 10A differs from the light reflective material 10 in that the light reflective material 10A further includes a buffer layer 4, which improves the adherence of the conducting film 2, between the base 1 and the conducting film 2. For example, when the base 1 is made of glass or zinc oxide, SiO₂ may be deposited on the surface of the base 1 as the buffer layer 4, and the conducting film 2 may be formed on the buffer layer 4. The conducting film 2 in this case has higher adherence and better quality than a conducting film 2 formed directly on the surface of the base 1 made of glass or zinc oxide.

In the formation of the buffer layer 4, the base 1 has a portion in contact with another base 1 or a stage on which the base 1 is placed as in the formation of the conducting film 2 and the insulating film 3 described above. The buffer layer 4 is not formed on the contact portion. Thus, there is a third region 4a where the buffer layer 4 is not formed. In FIG. 1(c), the position of the third region 4a overlaps the position of the first region 2a and the position of the second region 3a. However, the position of the third region 4a does not necessarily overlap the position of the first region 2a or the position of the second region 3a.

### (Method for Producing Light Reflective Material 10A)

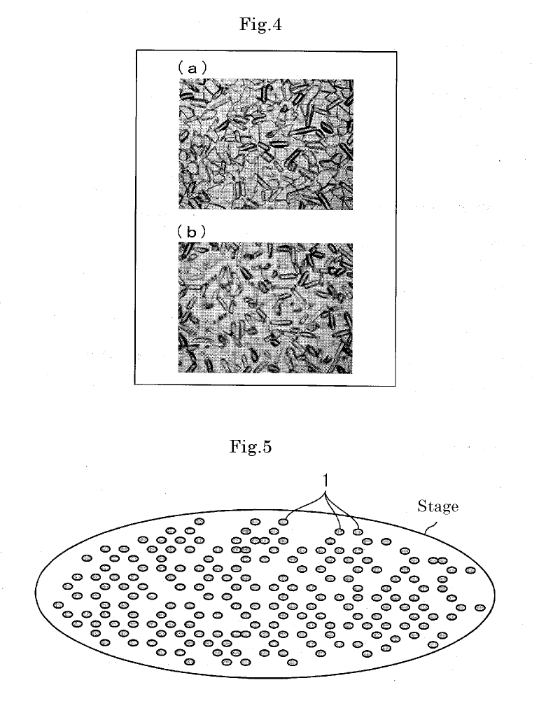

FIG. 5 is a view showing an example method for producing the light reflective material 10A. An example method for producing the light reflective material 10A using a DC magnetron sputtering system will be described below. The DC magnetron sputtering system used in the production method described below includes a vacuum chamber. The vacuum chamber in the DC magnetron sputtering system contains a stage on which a workpiece is to be placed, and a target holder that can hold at least two targets serving as deposition materials and enables switching of the target used for deposition.

First, (i) a Si target and (ii) ITO (ITO target) containing 5% SnO₂ were fixed to the target holder as targets. Next, glass flakes serving as the bases 1 were placed on the stage as illustrated in FIG. 5.

Next, the vacuum chamber was evacuated to 5×10⁻⁴ Pa using a turbo molecular pump. To the evacuated vacuum chamber, a mixture of an Ar gas and an O₂ gas was introduced at an Ar gas flow rate of 160 sccm and an O₂ gas flow rate of 40 sccm, and the inner pressure of the vacuum chamber was controlled at 0.5 Pa. In this state, a power of 1 kW was applied to the Si target to form a SiO₂ thin film having a thickness of about 50 nm as the buffer layer 4.

Subsequently, the stage was heated to 150° C. and maintained at 150° C. To the vacuum chamber, a mixture of an Ar gas and an O₂ gas was introduced at an Ar gas flow rate of 198 sccm and an O₂ gas flow rate of 2 sccm and the inner pressure of the vacuum chamber was controlled at 0.5 Pa. In this state, a power of 1 kW was applied to the ITO target to form an ITO thin film having a thickness of about 30 nm on the buffer layer 4 as the conducting film 2.

Subsequently, while the stage was maintained at 150° C., a mixture of an Ar gas and an O₂ gas was introduced to the vacuum chamber at an Ar gas flow rate of 160 sccm and an O₂ gas flow rate of 40 sccm, and the inner pressure of the vacuum chamber was controlled at 0.5 Pa. In this state, a power of 1 kW was applied to the Si target to form, on the conducting film 2, a SiO₂ thin film having a thickness of about 50 nm as the insulating film 3. The light reflective material 10A in which the buffer layer 4, the conducting film 2, and the insulating film 3 were sequentially formed on the base 1 was produced accordingly.

### (Effect of Sight Reflective Material 10)

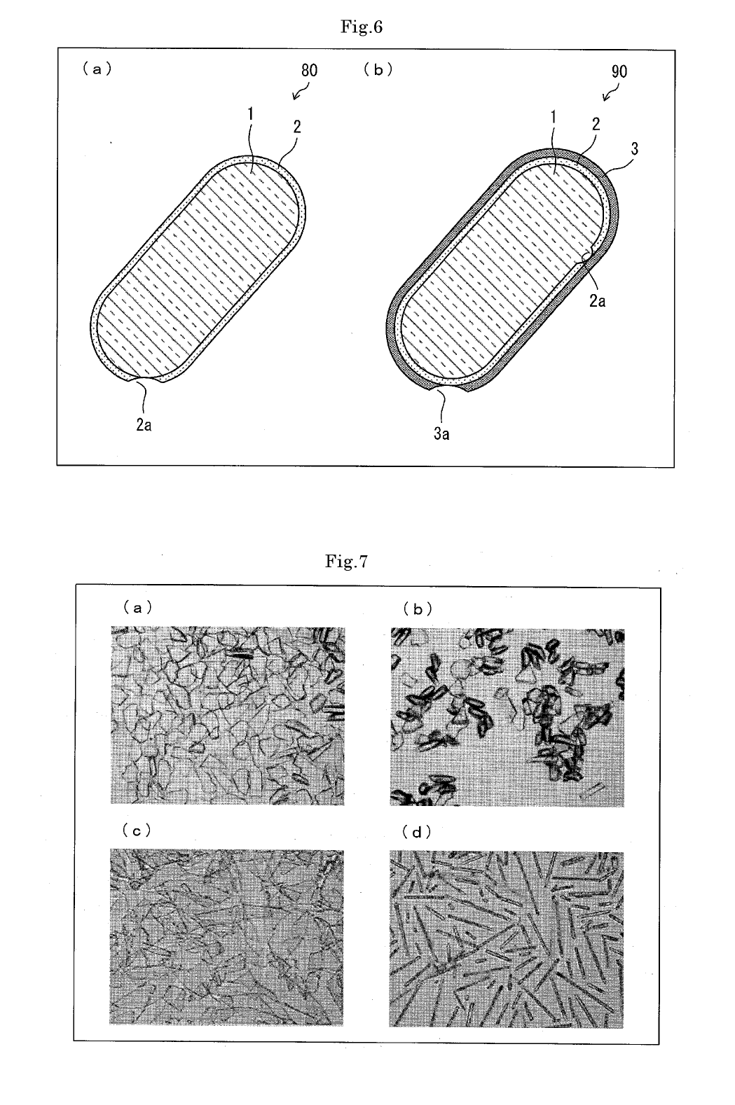

FIG. 6(a) is a cross-sectional view showing the structure of a light reflective material 80 of Comparative Example (Comparative Example 1). FIG. 6(b) is a cross-sectional view showing the structure of a light reflective material 90 of Comparative Example (Comparative Example 2) different from the light reflective material 80.

The light reflective material 80 differs from the light reflective material 10 in that the light reflective material 80 has no insulating film 3. The light reflective material 90 differs from the light reflective material 10 in that the position of the first region 2a does not overlap the position of the second region 3a of the insulating film because the conducting film 2 and the insulating film 3 are not continuously formed in the light reflective material 90.

In the case of the light reflective material 80, the conducting film 2 is entirely exposed. In the case of the light reflective material 90, the conducting film 2 is partially exposed through the second region 3a. The exposed portion of the conducting film 2 in the light reflective materials 80 and 90 has a larger area than that in the light reflective material 10. When a voltage is applied to the light reflective materials 80 and 90, a large Coulomb force is generated in the exposed portion of the conducting film 2 due to electrostatic induction. In a portion of the conducting film 2 coated with the insulating film 3, only polarization is generated the insulating film 3, and a large Coulomb force is not generated.

Therefore, when the light reflective materials 80 and 90 in which the exposed portion of the conducting film 2 has a larger area than that in the light reflective material 10 are used in the light control device 100, the Coulomb force interacting between the light reflective materials 80 and 90 in response to voltage application is larger than that in the case of using the light reflective material 10. As a result, the repeated voltage application may cause the light reflective materials 80 and 90 to move and aggregate, which may hinder stable switching between reflection and transmission of near-infrared light.

In the light reflective material 10, the position of the first region 2a of the conducting film 2 at least partially overlaps the position of the second region 3a of the insulating film 3 because the conducting film 2 and the insulating film 3 are continuously formed. An exposed portion of the conducting film 2 is the light reflective material 10 has a smaller area than that in the light reflective materials 80 and 90.

The exposure of the conducting film 2 in the light reflective material 10 is the minimum exposure that is unavoidable during the production of the light reflective material 10. It can be thus said that the conducting film 2 is barely exposed in the light reflective material 10. Specifically, the exposed portion of the conducting film 2 in the light reflective material 10 is as small as the cross section of the conducting film 2 in the first region 2a.

In the case of using the light reflective material 10 in the light control device 100, the Coulomb force interacting between the light reflective materials 10 in response to voltage application is thus smaller than that in the case of using the light reflective materials 80 and 90. A smaller Coulomb force reduces the movement and aggregation of the light reflective materials 10. Therefore, the light control device 100 including the light reflective material 10 enables stable switching between the near-infrared light transmission state and the near-infrared light reflection state.

Most of infrared radiation from the sun is near-infrared radiation. Thus, controlling the solar heat gain coefficient is substantially equivalent to controlling the near-infrared transmittance. There is also a need to prevent infrared rays from going out from the room in the winter. The infrared rays here, however, have a wavelength of about 10 μm and are classified into far-infrared rays.

The electrodes 112 and 122, which are transparent conducting films that transmit near-infrared rays, have a property of reflecting far-infrared rays. Thus, the light control device 100 always reflects far-infrared light that is, even when the light control device 100 is controlled such that near-infrared rays from the outdoors enter the room in the winter, the indoor heat does not escape as radiant heat, thereby providing ideal conditions. When the light control device 100 is controlled so as to prevent near-infrared rays from entering the room in the summer, far-infrared rays do not enter either, thereby providing ideal conditions.

The light reflective material 10 in this embodiment described above reflects near-infrared light. The light reflective material 10 does not necessarily reflect near-infrared light and may reflect light with particular wavelengths, for example, visible light of a particular color. In this case, the material of each component in the light reflective material 10 is appropriately changed depending on the wavelength of light to be reflected.

For example, gold may be used as a material of the conducting film 2. Gold has a property of having a larger reflectance for light with wavelengths of 600 nm or more than that for light with wavelengths of less than 600 nm. Therefore, the light control device 100 including the light reflective material 10 in which the conducting film 2 is made of gold transmits visible light with wavelengths of less than 600 nm and switches between the transmission state and the reflection state of visible light with wavelengths of 600 nm or more.

Instead of the conducting film 2, the base 1 may be made of a material that reflects or absorbs light with a particular wavelength. In other words, the light reflective material may include a base that reflects or absorbs light with a particular wavelength, a conducting film stacked on the base, and an insulating film stacked on the conducting film. In this case, examples of the material of the base include Ag nanoparticles, ITO nanoparticles, and glass containing a dye that absorbs near-infrared light. In this case, the base is not a film and, therefore, a material with which it is difficult to form a film can be used as a material that reflects light with a particular wavelength.

In addition, the base 1 may be in the form of needle-like crystal instead of being in the form of flakes. In this case, the light control device 100 is a suspended particle device (SPD) that switches absorption of outside light between the random state and the electric-field parallel state of needle-like crystal by rotation of needle-like light reflective materials 10 in response to voltage.

### (Experiment)

The light control device 100 according to this embodiment and a light control device of Comparative Example 3 were produced, and an experiment involving repeated voltage application was carried out. As used herein, the term “repeated voltage application” means repeated switching between application of a voltage that causes the near-infrared light reflection state and application of a voltage that causes the near-infrared light transmission state in terms of the voltage between the electrodes 112 and 122. In this experiment, the “voltage that causes the near-infrared light reflection state” is a direct current voltage of 2 V. The “voltage that causes the near-infrared. light transmission state” is an alternating voltage with an amplitude of 5 V and a frequency of 60 Hz.

The light control device 100 includes, as a light reflective material, the light reflective material 10 having a diameter of 50 to 200 μm and including a base 1 made of glass, a conducting film 2 made of ITO, and an insulating film 3 made of SiO₂. The light control device of Comparative Example 3 includes, as a light reflective material, a light reflective material 80 having a diameter of 50 to 100 μm and including a base 1 made of glass and a conducting film 2 made of ITO. Other components, such as the electrodes 112 and 122, are the same in the light control device 100 and the light control device of Comparative Example 3.

FIG. 7(a) is a micrograph when the light control device of Comparative Example 3 in the near-infrared light reflection state is observed from the light-receiving side. FIG. 7(b) is a micrograph showing the near-infrared light transmission state after voltage application to the light control device of Comparative Example 3 is repeated 10 times. FIG. 7(c) is a micrograph when the light control device 100 in the near-infrared light reflection state is observed from the light-receiving side. FIG. 7(d) is a micrograph showing the near-infrared light transmission state after voltage application to the light control device 100 is repeated 10 times.

The voltage application to the light control device of Comparative Example 3 in the state illustrated in FIG. 7(a) was repeated 10 times. Specifically, the following procedure was repeated 10 times: (i) switching the light reflective material 10 from the near-infrared light reflection state to the near-infrared light transmission state by application of an alternating voltage for 1 second; and (ii) then switching the light reflective material 10 from the near-infrared light transmission state to the near-infrared light reflection state by application of a direct current voltage. Accordingly, an alternating voltage was applied to the light reflective material 10 for total 10 seconds.

As illustrated in FIG. 7(b), the light reflective materials 80 moved and aggregated at this time. As a result, some of the light reflective materials 80 were oriented in directions substantially parallel to the substrates 110 and 120 in the near-infrared light transmission state. The movement of some of the light reflective materials 80 causes the light modulation layer 130 to have regions where the light reflective materials 80 are not present as illustrated in FIG. 7(b).

The voltage application to the light control device 100 in the state illustrated in FIG. 7(c) was repeated 10 times. As illustrated in FIG. 7(d), the light reflective materials 10 did not move or aggregate at this time.

### Second Embodiment

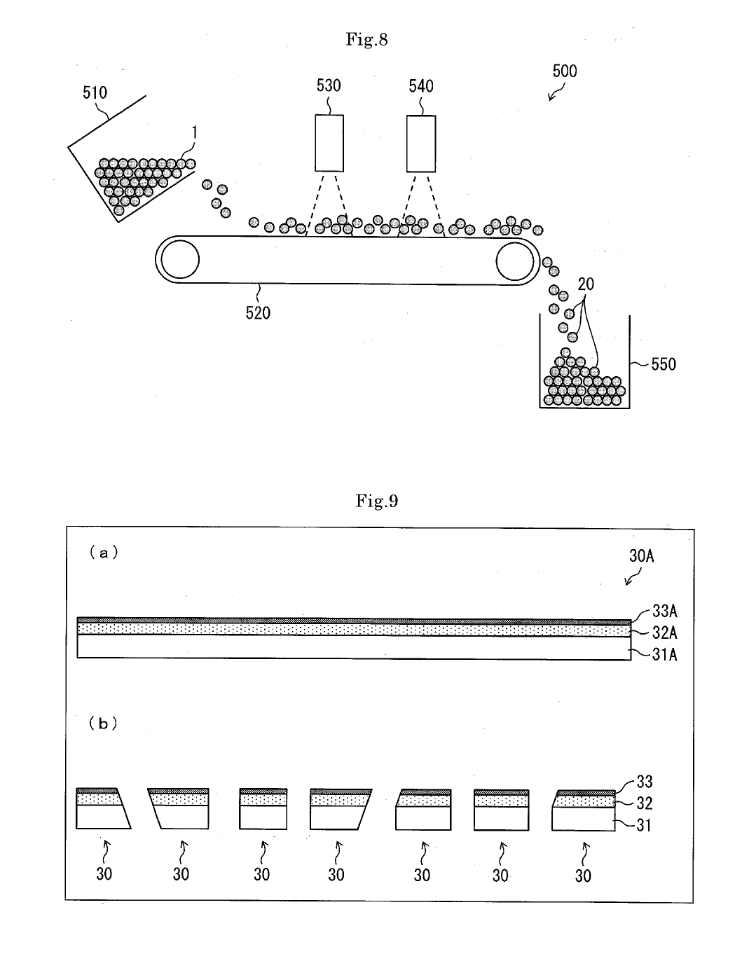

Another embodiment of the discloser will be described below with reference to FIG. 8. For convenience of description, any components having the same functions as the components described in the foregoing embodiment will be provided with the same reference characters, and redundant description thereof will be avoided.

FIG. 8 is a view showing a method for producing the light reflective material 20 according to this embodiment. Like the light reflective material 10 illustrated in FIG. 1(b), the light reflective material 20 includes a base 1, a conducting film 2, and an insulating film 3. In this embodiment, the light reflective material 20 is produced by continuous deposition of ITO and SiO₂ on the base 1 using a mist-CVD method.

As illustrated in FIG. 8, a conveyor furnace 500 is used to produce the light reflective material 20 in this embodiment. The conveyor furnace 500 includes a base supply unit 510, a conveyor belt 520, a first deposition unit 530, a second deposition unit 540, and a light reflective material collector 550.

The base supply unit 510 supplies glass flakes serving as the bases 1 onto the conveyor belt 520. The conveyor belt 520 moves the base 1 supplied from the base supply unit 510 to the light reflective material collector 550.

The first deposition unit 530 forms the conducting film 2 on the base 1. Specifically, the first deposition unit 530 atomizes an ITO deposition solution (acetylacetone solution containing 0.1 mol/l of indium acetylacetone containing 12% by weight of tin(IV) chloride) using ultrasonic waves and sprays the atomized ITO deposition solution into the conveyor furnace 500 using air as a carrier gas. The ITO deposition solution sprayed into the conveyor furnace 500 is thermally decomposed by contact with the base 1 on the conveyor belt 520 to form the conducting film 2 on the base 1.

The second deposition unit 540 forms the insulating film 3 on the conducting film 2. Specifically, the second deposition unit 540 operates in the same manner as the first deposition unit 530 except that a SiO₂ deposition solution (tetraethoxysilane) is used for deposition instead of the ITO deposition solution. The second deposition unit 540 is more distant from the base supply unit 510 than the first deposition unit 530.

The light reflective material collector 550 receives and collects the light reflective materials 20 dropped from the end of the conveyor belt 520 distant from the base supply unit 510.

The light reflective materials 20 are produced as described below. First, the conveyor furnace 500 is heated to 500° C. Next, glass flakes serving as the bases 1 are supplied from the base supply unit 510 onto the conveyor belt 520. The first deposition unit 530 and the second deposition unit 540 form the conducting film 2 and the insulating film 3 on the surfaces of the bases 1 moving on the conveyor belt 520 to produce the light reflective material 20. Since the bases 1 are moved by the conveyor belt 520 at this time, a portion of one base 1 in contact with another base 1 or a portion of one base 1 in contact with a stage or the like on which the base 1 is placed is not changed during the time between the formation of the conducting film 2 and the formation of the insulating film 3. In other words, the conducting film 2 and the insulating film 3 are continuously formed.

The light reflective materials 20 then drop from the end of the conveyor belt 520 and are received and collected by the light reflective material collector 550.

Like the light reflective materials 10, the light reflective materials 20 thus produced can be used in a light control device that switches between the near-infrared light reflection state and the near-infrared light transmission state by rotation of light reflective materials in, for example, the light control device 100.

### Third Embodiment

Another embodiment of the discloser will be described below with reference to FIG. 9. FIG. 9(a) is a view showing the structure of a light reflective material wafer 30A. FIG. 9(b) is a view showing the light reflective material wafer 30A illustrated in FIG. 9(a) when it has been ground into small pieces.

A method for producing the light reflective material according to this embodiment will be described below. First, as illustrated in FIG. 9(a), the light reflective material wafer 30A is produced by sequentially forming a conducting film 32A and an insulating film 33A on a glass sheet 31A having a thickness of 50 μm. In this embodiment, the conducting film 32A is a GZO film having a thickness of 500 nm. The insulating film 33A is a SiO₂ film having a thickness of 50 nm. The conducting film 32A and the insulating film 33A can be formed by any known method, such as bar coating, spin coating, printing, or dip coating.

Next, the light reflective material wafer 30A is ground into small pieces using a ball mill to produce light reflective materials 30 as illustrated in FIG. 9(b). In this embodiment, the light reflective material wafer 30A is ground into the light reflective materials 30 having a diameter as small as 100 μm.

As described above, the light reflective materials 10 are preferably 50 μm in diameter and 20 μm in thickness in the first embodiment. Since the light reflective material 30 in this embodiment is larger than the preferred size, the light reflective material 30 is less responsive to voltage application than the light reflective material 10. The use of a commercially available glass sheet 50 μm thick has an advantage that light reflective materials can be produced easily.

Like the light reflective materials 10, the light reflective materials 30 thus produced can be used in a light control device that switches between the near-infrared light reflection state and the near-infrared light transmission state by rotation of light reflective materials in, for example, the light control device 100.

### Fourth Embodiment

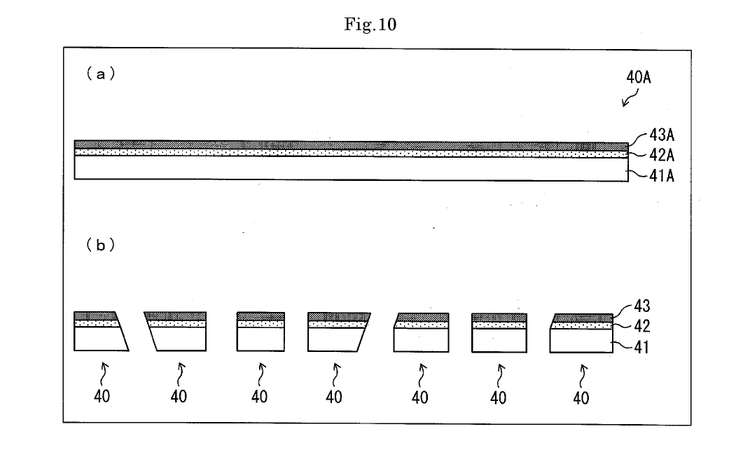

Another embodiment of the discloser will be described below with reference to FIG. 10. FIG. 10(a) is a view showing the structure of a light reflective film 40A. FIG. 10(b) is a view of the light reflective film 40A illustrated in FIG. 10(a) when it has been divided into small pieces.

A method for producing the light reflective material according to this embodiment will be described below. First, as illustrated in FIG. 10(a), a light reflective film 40A is produced by forming a conducting film 42A and an insulating film 43A on a film 41A having a thickness of 4 μm. Examples of the material of the film 41A include polyethylene terephthalate (PET) and polyimide. In particular, PET is preferably used as a material of the film 41A from an economical viewpoint. In this embodiment, the conducting film 42A is a silver film having a thickness of 10 nm and is formed by vapor deposition.

The insulating film 43A is a SiO₂ film having a thickness of 50 nm. The material of the insulating film 43A is not limited to SiO₂, and the insulating film 43A may be made of resin. Like the conducting film 32A and the insulating film 33A in the third embodiment, the insulating film 43A can be formed by any known method, such as bar coating, spin coating, printing, or dip coating.

Next, as illustrated in FIG. 10(b), light reflective materials 40 are produced by dividing the light reflective film 40A. In this embodiment, the light reflective film 40A is divided into the light reflective materials 40 having a diameter of 100 μm or less.

Like the light reflective materials 10, the light reflective materials 40 thus produced can be used in a light control device that switches between the near-infrared light reflection state and the near-infrared light transmission state by rotation of light reflective materials in, for example, the light control device 100.

### Summary

A light reflective material (10) according to the first embodiment of the discloser is a light reflective material that reflects light with a particular wavelength. The light reflective material (10) includes a light-transmissive base (1), a conducting film (2) that is stacked on the surface of the base and reflects the light with a particular wavelength, and an insulating film (3) that is stacked on the surface of the conducting film. A first region (2a) where the conducting film is not formed is present in a layer where the conducting film lies. A second region (3a) where the insulating film is not formed is present in a layer where the insulating film lies. The first region and the second region at least partially overlap each other.

According to the aforementioned structure, the light reflective material includes the base, the conducting film, and the insulating film. The conducting film or the insulating film is not formed on a portion of the base in contact with another object during deposition. For this, a first region where the conducting film is not formed is present in a layer where the conducting film lies, and a second region where the insulating film is not formed is present in a layer where the insulating film lies. Since the position of the first region and the position of the second region at least partially overlap each other, the exposed portion of the conducting film has a small area. The Coulomb force interacting between the light reflective materials in response to voltage application is thus small, which reduces the movement and aggregation of the light reflective materials. Therefore, a light reflective material that enables stable switching between light transmission and light reflection when used in a light control device can be obtained.

In a light reflective material according to a second aspect of the discloser, the light with a particular wavelength in the first aspect is preferably near-infrared light.

According to the aforementioned structure, the use of the light reflective material in the light control device installed in a window enables control of near-infrared light entering the room and can make an indoor environment comfortable.

In a light reflective material according to a third aspect of the discloser, a material of the conducting film in the second aspect is preferably indium tin oxide, gallium-doped zinc oxide, aluminum-doped zinc oxide, an InGaZnO oxide semiconductor, or any of the foregoing doped with an impurity.

According to the aforementioned structure, the conducting transmits 50% or more of visible light. Therefore, the light reflective material can be used suitably in a light control device to be installed in a window.

In a light reflective material according to a fourth aspect of the discloser, the light reflective material in any one of the first to third aspects preferably has a diameter of 50 μm or less and a thickness of 20 μm or less.

According to the aforementioned structure, the light reflective material has a small mass, which reduces an energy needed to switch between the near-infrared light reflection state and the near-infrared light transmission state.

In a light reflective material according to a fifth aspect of the discloser, the material of the base in the fourth aspect is preferably glass.

According to the aforementioned structure, it is easy to form the base such that the light reflective material has the size described in the fourth aspect.

In a light reflective material according to a sixth aspect of the discloser, the light reflective material in any one of the first to fifth aspects preferably further includes a buffer layer (4), which improves the adherence of the conducting film, between the base and the conducting film.

According to the aforementioned structure, the conducting film has higher adherence and better quality than a conducting film formed directly on the base.

A light reflective material according to a seventh aspect of the discloser is a light reflective material that reflects light with a particular wavelength. The light reflective material includes a base that reflects the light with a particular wavelength, a conducting film that is stacked on the surface of the base, and an insulating film that is stacked on the surface of the conducting film. A first region where the conducting film is not formed is present in a layer where the conducting film lies. A second region where the insulating film is not formed is present in a layer where the insulating film lies. The first region and the second region at least partially overlap each other.

According to the aforementioned structure, the same advantageous effects as in the first aspect are obtained.

A light control device (100) according to an eighth aspect of the discloser preferably includes the light reflective material according to any one of the first to seventh aspects.

According to the aforementioned structure, the light control device can stably switch between the light reflection state and the light transmission state.

The discloser is not limited to the embodiments described above, and various modifications can be made without departing from the scope of the discloser defined in the claims. Embodiments obtained by appropriately combining the technical means disclosed in different embodiments are also within the technical scope of the discloser. Furthermore, new technical features can be formed by combining the technical means disclosed in the embodiments.

### CROSS-REFERENCE TO RELATED APPLICATION

The present application claims priority from Japanese Patent Application No. 2015-250545 filed Dec. 22, 2015, the entire contents of which are hereby incorporated by reference.

### REFERENCE SIGNS LIST

1 Base
2, 32A, 42A Conducting film
3, 33A, 43A Insulating film
2a First region
3a Second region
4 Buffer layer
10, 10A, 20, 30, 40 Light reflective material
100 Light control device

1-8. (canceled)

9. A light reflective material comprising;
a base,
a conductive film disposed at a portion of a first surface of the base,
an insulating film disposed at a portion of a surface of the conduction film, wherein
either the base or conductive film has a light transmissive characteristic.

10. The light reflective material according to claim 9, wherein
the base is a transmissive base and
the conductive film reflects a near infrared light.

11. The light reflective material according to claim 9, wherein
the base reflects a near infrared light and
the conductive film comprises a transparent conducting film.

12. The light reflective material according to claim 9, wherein
the base is covered with the conducting film and has a second surface of the base not covered with the conductive film and the insulating film, and being continuous with first surface of the base.

13. The light reflective material according to claim 9, wherein
the base is covered with the conducting film,
the insulating film is covered with the conductive film,
a first region where the base is exposed overlaps with the second region where the conductive layer is exposed.

14. The light reflective material according to claim 9, wherein a material of the conducting film is indium tin oxide, gallium-doped zinc oxide, aluminum-doped zinc oxide, an InGaZnO oxide semiconductor, or any of the foregoing doped with an impurity.

15. The light reflective material according to claim 9, wherein
the light reflecting material has a oblate ellipsoid shape,
the oblate ellipsoid shape has a diameter of 50 um or less and a thickness of 20 um or less.

16. The light reflective material according to claim 9, wherein a material of the base is glass.

17. The light reflective material according to claim 9, further comprising a buffer layer, which improves adherence of the conducting film, between the base and the conducting film.

18. A light control device comprising
a first transmissive substrate,
a second transmissive substrate facing to the first transmissive substrate,
a first transmissive electrode disposed on the first transmissive substrate,
a second transmissive electrode disposed on the second transmissive substrate and arranged between the first transmissive electrode and the second transmissive substrate,
a medium arranged between the first transmissive electrode and the second transmissive substrate,
a light reflective material included in the medium comprising;
a base,
a conductive film disposed at a portion of a first surface of the light transmissive base,
an insulating film disposed at a portion of a surface of the conduction film, wherein
either the base or conductive film has a light transmissive characteristic.

19. The light control device according to claim 18, wherein
the base is a transmissive base and
the conductive film reflects a near infrared light.

20. The light control device according to claim 18, wherein
the base reflects a near infrared light and
the conductive film comprises a transparent conducting film.

21. The light control device according to claim 18, wherein
the base is covered with the conducting film and has a second surface of the base not covered with the conductive film and the insulating film, and being continuous with first surface of the base.

22. The light control device according to claim 18, wherein
the base is covered with the conducting film,
the insulating film is covered with the conductive film,
a first region where the base is exposed overlaps with the second region where the conductive layer is exposed.

23. The light control device according to claim 18, wherein a material of the conducting film is indium tin oxide, gallium-doped zinc oxide, aluminum-doped zinc oxide, an InGaZnO oxide semiconductor, or any of the foregoing doped with an impurity.

24. The light control device according to claim 18, wherein
the light reflecting material has a oblate ellipsoid shape,
the oblate ellipsoid shape has a diameter of 50 um or less and a thickness of 20 um or less.

25. The light control device according to claim 18, wherein a material of the base is glass.

26. The light control device according to claim 18, further comprising a buffer layer, which improves adherence of the conducting film, between the base and the conducting film.

27. The light control device according to claim 26, wherein
the buffer layer comprising SiO₂ film.

28. The light control device according to claim 18, wherein
the medium is at least one selected from the group consisting of propylene carbonate, N-methyl-2-pyrrolidone (NMP), fluorocarbon, and silicone oil.
